(19) United States
(12) Patent Application Publication
(10) Pub. No.: US 2016/0283044 A1
(43) Pub. Date: Sep. 29, 2016

(54) DISPLAY APPARATUS, DISPLAY CONTROL METHOD, AND COMPUTER READABLE RECORDING MEDIUM HAVING PROGRAM STORED THEREIN

(71) Applicant: CASIO COMPUTER CO., LTD., Tokyo (JP)

(72) Inventor: Toshihiro Ohsawa, Tokyo (JP)

(21) Appl. No.: 15/071,380

(22) Filed: Mar. 16, 2016

(30) Foreign Application Priority Data
Mar. 23, 2015 (JP) 2015-059347

(51) Int. Cl. G06F 3/0481

(52) U.S. Cl. CPC G06F 3/0481

(57) ABSTRACT

A display control method performed by a control unit for controlling a display unit of a display apparatus includes determining whether or not a user's activity state changes based on at least one of pieces of indicator information, the pieces of indicator information being detected by at least one sensor and associated with the user's activity state, and controlling the display unit including a first and a second display areas such that a display in the first display area is emphasized as compared with a display in the second display area in the case that it is determined that the user's activity state changes. The display in the first display area corresponds to first information. The display in the second display area corresponds to second information which is different from the first information. The first information has high relevance to the changed user's activity state compared to the second information.

### CROSS-REFERENCE TO RELATED APPLICATIONS

This application is based upon and claims the benefit of priority under 35 USC 119 of Japanese Patent Application No. 2015-059347 filed on Mar. 23, 2015, the entire disclosure of which is incorporated herein by reference in its entirety for all purposes.

### BACKGROUND OF THE INVENTION

1. Field of the Invention

The present invention relates to a display apparatus, a display control method, and a computer readable recording medium having a program stored therein.

2. Description of the Related Art

Conventionally, there has been known a watch-type product as a wearable device which can be worn on the body of a user and carried by the user. For example, Japanese Patent Application Laid-Open Publication No. 2006-171412 published on Jun. 29, 2006, discloses a wearable device having a display unit with a display screen disposed along almost the whole of a ring-shaped frame of the product.

However, since the device disclosed in the above document needs to be compact and lightweight, a small capacity battery should be installed in the device. Thus, the device cannot endure a long term use.

### SUMMARY OF THE INVENTION

The present invention was made in light of the problem mentioned above, and an object of the present invention is to provide a display apparatus which can endure a long term use, and a display control method and a computer readable recording medium having a program thereof.

According to an embodiment of the present invention, a display control method performed by a control unit for controlling a display unit of a display apparatus is provided. The display control method includes determining whether or not a user's activity state changes based on at least one of pieces of indicator information, the pieces of indicator information being detected by at least one sensor and being associated with the user's activity state, and controlling the display unit which includes a first display area and a second display area such that a display in the first display area is emphasized as compared with a display in the second display area in the case that it is determined that the user's activity state changes. The display in the first display area is corresponding to first information of the pieces of indicator information, the display in the second display area is corresponding to second information of the pieces of indicator information, and the second information is different from the first information. The first information has high relevance to the changed user's activity state compared to the second information.

### BRIEF DESCRIPTION OF THE DRAWINGS

The present invention will more sufficiently be understood by the following detailed description and the accompanying drawings, which are, however, exclusively for explanation and do not limit the scope of the present invention.

Here:

FIG. 1 shows a schematic diagram of a wearable terminal according to one embodiment to which the present invention is applied.

FIG. 2 is a block diagram showing a schematic configuration of a wearable terminal according to one embodiment to which the present invention is applied.

FIG. 3 is a flow chart showing an example of a first to third display areas control process by the wearable terminal of FIG. 1.

FIG. 4 is a flow chart showing an example of a fourth display area control process by the wearable terminal of FIG. 1.

FIG. 5 is a flow chart showing an example of a fifth display area control process by the wearable terminal of FIG. 1.

FIGS. 6A to 6C are diagrams showing brightness levels of a display unit.

FIG. 7 is a signal waveform diagram showing an example of acceleration information output by an acceleration sensor during walking and running.

FIG. 8 is a signal waveform diagram for showing an example of a pulse waveform.

FIG. 9 is a diagram showing an example of lowering the brightness level of a part of display areas of the display unit by one step.

FIG. 10A is a diagram showing an example of display of the display unit when a user stands still on flat land (at a place of uniform height). FIG. 10B is a diagram showing an example of display of the display unit when the user is running.

FIG. 11A is a diagram showing an example of changing the size of a part of the display areas of the display unit. FIG. 11B is a diagram showing an example of changing the size and brightness of a part of the display areas of the display unit.

### DETAILED DESCRIPTION OF THE PREFERRED EMBODIMENT

Hereinafter, embodiments of the present invention will be described with reference to the accompanying drawings. The scope of the invention is not intended to be limited to the illustrated examples.

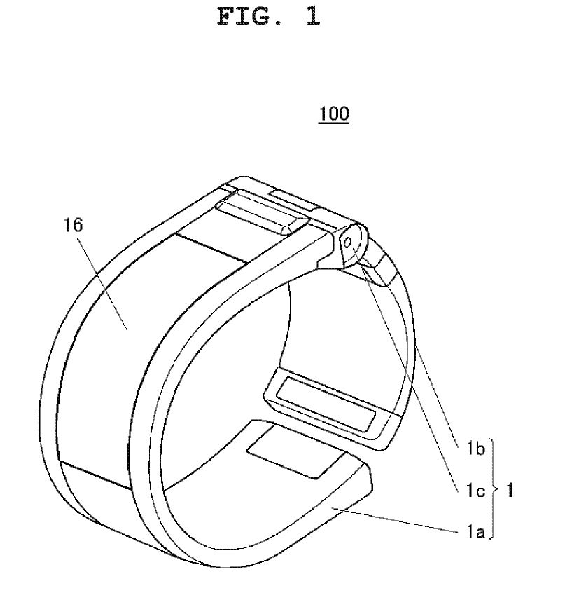

FIG. 1 shows a schematic diagram of a wearable terminal 100 which is an embodiment of a display apparatus of the present invention.

As shown in FIG. 1, the wearable terminal 100 of the present embodiment is a watch-type device and includes a band unit 1 and a display unit 16.

The band unit 1 includes a first band 1a and a second band 1b which are curved and formed of resin and a hinge 1c connecting the first band 1a and the second band 1b. The second band 1b can be tilted with respect to the first band 1a by the hinge 1c. Thus, the band unit 1 can be transformed between a first state where it is ring-shaped (shown in FIG. 1) and a second state where it is released from the first state (i.e. it is not ring-shaped). The wearable terminal 100 of the present embodiment can be worn on an arm when it is in the second state and locked around the arm when it is transformed to the first state.

The display unit 16, which will be described later, is installed on and over an outer circumferential surface of the first band 1a. Further, a touch panel which is a manipulation unit 18 (not shown in the drawing) is provided on the display unit 16.

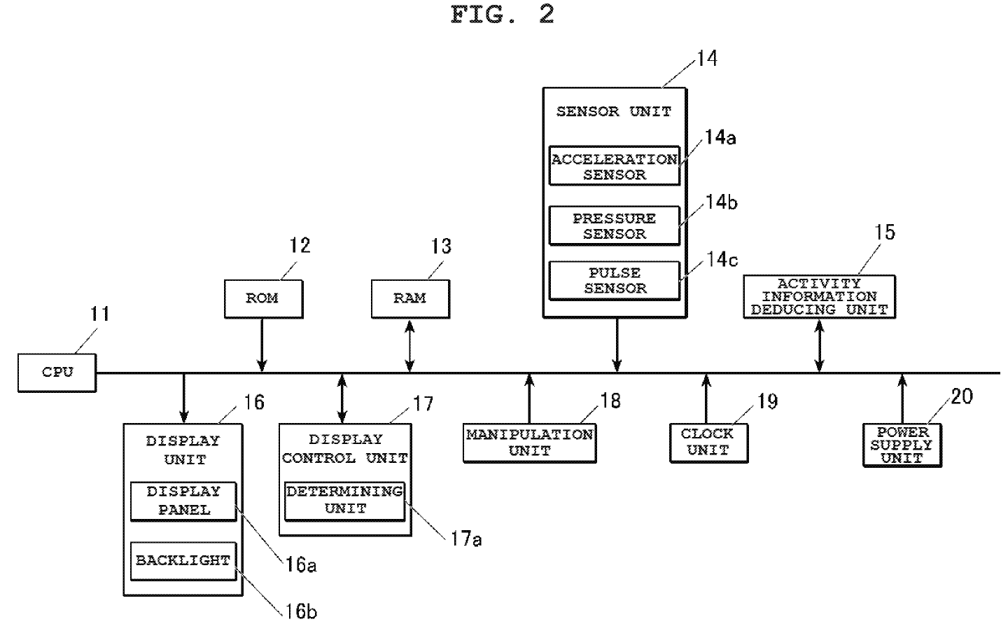

FIG. 2 is a block diagram showing a schematic configuration of the wearable terminal 100 according to the present embodiment.

As shown in FIG. 2, the wearable terminal 100 includes a CPU (Central Processing Unit) 11, a ROM (Read Only Memory) 12, a RAM (Random Access Memory) 13, a sensor unit 14, an activity information deducing unit 15, a display unit 16, a display control unit 17, a manipulation unit 18, a clock unit 19, and a power supply unit 20.

The CPU 11 performs a variety of processing and controls overall operations of the wearable terminal 100. In the present embodiment, the CPU 11 instructs the display control unit 17 to control display and performs processing related to various other functions.

In the ROM 12, there are stored various programs executed by the CPU 11 and/or initial setting data.

The RAM 13 provides a work memory space for the CPU 11. In the RAM 13, there is stored temporary work data.

The sensor unit (an indicator information detecting unit) 14 detects indicator information showing an activity state of a person wearing the wearable terminal 100 (hereinafter, referred to as a “user”). The sensor unit 14 includes an acceleration sensor 14a, a pressure sensor 14b, and a pulse sensor 14c.

The acceleration sensor 14a is embedded in the wearable terminal 100. The acceleration sensor 14a detects acceleration information (indicator information; sensor data) showing a rate of change in speed (an acceleration) while the user is doing exercise and outputs the acceleration information. The acceleration information is stored in a predetermined storage area of the RAM 13.

Similarly to the acceleration sensor 14a, the pressure sensor 14b is embedded in the wearable terminal 100. The pressure sensor 14b detects air pressure information (indicator information; sensor data) showing air pressure and outputs the air pressure information. The air pressure information is stored in a predetermined storage area of the RAM 13.

The pulse sensor (a reflective optical sensor) 14c is disposed facing a skin surface of the user's arm, for example, in an inner surface of the first band 1a. The pulse sensor 14c uses the property that hemoglobin in arterial blood absorbs light and measures light returning from the inside of the user's skin by a light receiving element. The pulse sensor 14c detects light quantity information (indicator information; sensor data) showing a measured quantity of light and outputs the light quantity information. The light quantity information is stored in a predetermined storage area of the RAM 13.

The activity information deducing unit (an activity information deducing means) 15 deduces activity information relating to the user's activity state based on a plurality of kinds of indicator information detected by the sensing unit 14.

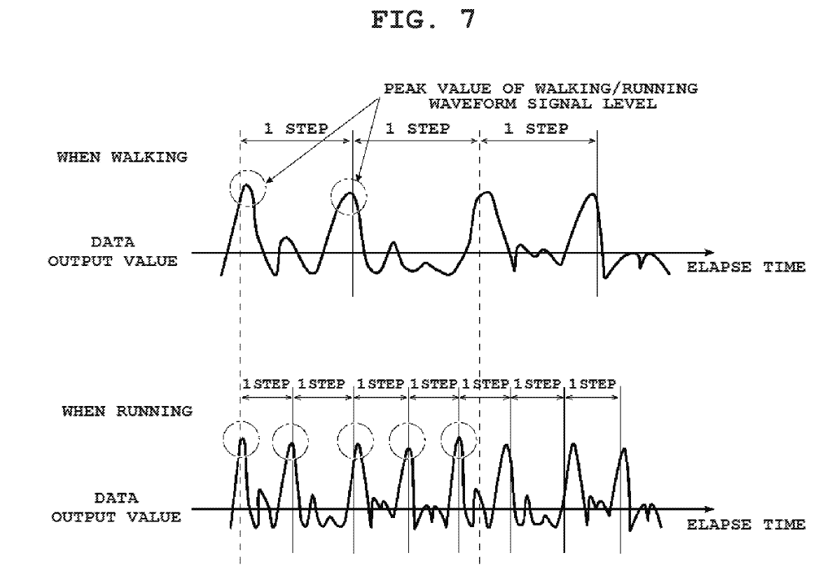

More specifically, the activity information deducing unit 15 acquires the acceleration information (the sensor data) detected by the acceleration sensor 14a from the RAM 13. Then, the activity information deducing unit 15 smoothes the acquired acceleration information to analyze the waveform signal (see FIG. 7). Then, the activity information deducing unit 15 determines whether or not a peak is detected from the analyzed waveform signal. In the case that the activity information deducing unit 15 determines a peak is detected from the waveform signal, it is regarded that the user has taken one step. Then, the activity information deducing unit 15 updates step count data, distance data, and calorie data and stores the updated data in a predetermined storage area of the RAM 13. The value of the distance data can be deduced by multiplying a value of data of the user's step width set in advance by the step count data. The value of the calorie data can be deduced by multiplying a value of data of the user's weight set in advance by the distance data.

Further, the activity information deducing unit 15 acquires the air pressure information (the sensor data) detected by the pressure sensor 14b from the RAM 13. Then, the activity information deducing unit 15 smoothes the acquired air pressure information and obtains a height from the air pressure information to store in a predetermined storage area of the RAM 13. Conversion from the air pressure to the height is not explained in detail here because it can be performed by using a well-known formula.

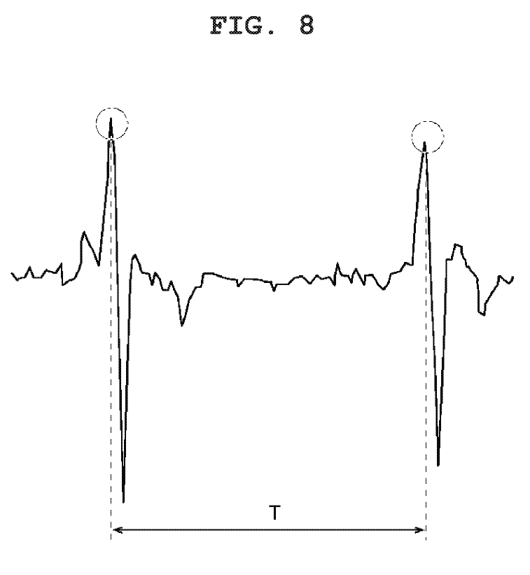

Further, the activity information deducing unit 15 acquires the light quantity information (the sensor data) detected by the pulse sensor 14c from the RAM 13. Then, the activity information deducing unit 15 smoothes the acquired light quantity information to analyze the waveform signal. The activity information deducing unit 15 determines whether or not a waveform pattern based on the waveform signal accords with a pulse waveform pattern. In the case of determining that the waveform pattern accords with the pulse waveform pattern, the activity information deducing unit 15 obtains a pulse rate from the analyzed waveform signal and stores the pulse rate in a predetermined storage area of the RAM 13. The pulse rate indicates the number of pulsation per minute. The pulse rate can be obtained, for example, by acquiring a time period T between peak levels of the pulse waveform as shown in FIG. 8.

The display unit (a display means) 16 includes a display panel 16a and a backlight 16b.

The display panel 16a includes an LCD (Liquid Crystal Display) device using the backlight 16b, which will be described later, as a light source.

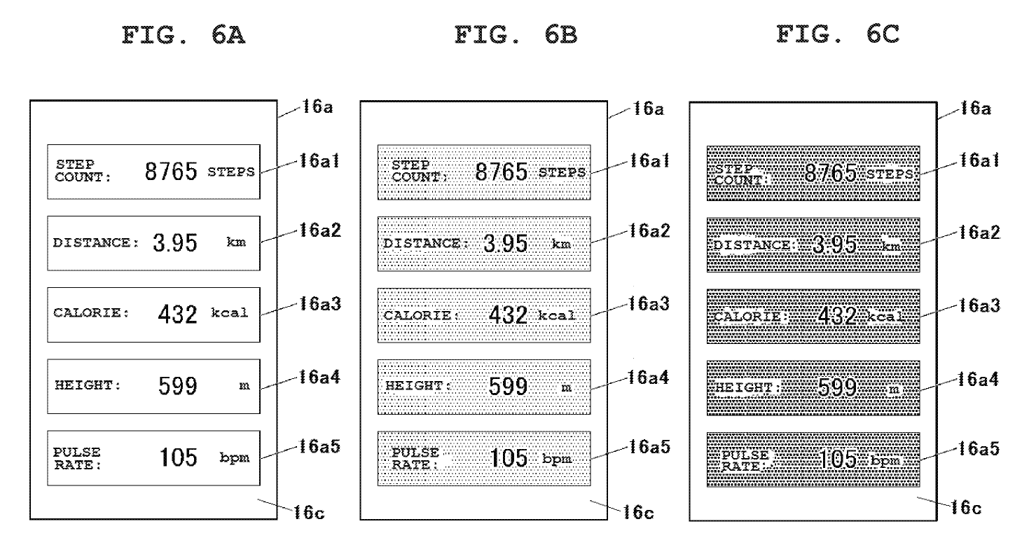

In the present embodiment, the display panel 16a includes a first display area 16a1 for showing the step count data, a second display area 16a2 for showing the distance data, a third display area 16a3 for showing the calorie data, a fourth display area 16a4 for showing the height data, a fifth display area 16a5 for showing the pulse rate data, and a background area 16c, as shown in FIGS. 6A to 6C.

The display panel 16a may be an OLED (Organic Light-Emitting Diode) device.

The backlight 16b is a light source device, for example, including an LED (Light Emitting Diode) array and emits light required by the display panel 16a. In the present embodiment, a brightness level can be adjusted in response to applied current in each of the first to the fifth display areas (16a1 to 16a5). More specifically, the brightness level can be adjusted to one of a brightness level 1 (normal brightness; 100% of brightness) as shown in FIG. 6A, a brightness level 2 (50% of brightness) as shown in FIG. 6B, and a brightness level 3 (10% of brightness) as shown in FIG. 6C. Even in the case that the brightness of each of the display areas 16a1 to 16a5 is changed, display data in the display area can be seen by setting the brightness of the display areas 16a1 to 16a5 so as to be different from that of the background area 16c.

In the present embodiment, the brightness level 3 is set to 10% so that the display data in the display area can be seen even if the brightness level is low. However, the brightness level 3 may be set to 0% (light-out).

The display control unit (a control means) 17 generates data for display and controls the display panel 16a to display the data.

In the present embodiment, the display control unit 17 generates data for display from the step count data, the distance data, and the calorie data stored in the RAM 13 and controls them to be displayed in the first display area 16a1, the second display area 16a2, and the third display area 16a3, respectively. Further, the display control unit 17 generates data for display from the height data stored in the RAM 13 and controls it to be displayed in the fourth display area 16a4. Furthermore, the display control unit 17 generates data for display from the pulse rate data stored in the RAM 13 and controls it to be displayed in the fifth display area 16a5.

In the present embodiment, the display control unit 17 includes a determining unit 17a.

The determining unit (a determining means) 17a determines whether or not the user's activity state changes based on the indicator information detected by the sensor unit 14.

More specifically, the determining unit 17a deduces speed data from the distance data deduced by the activity information deducing unit 15 and clock data measured by the clock unit 19 (which will be described later) and determines whether or not the user is walking or running from the speed data.

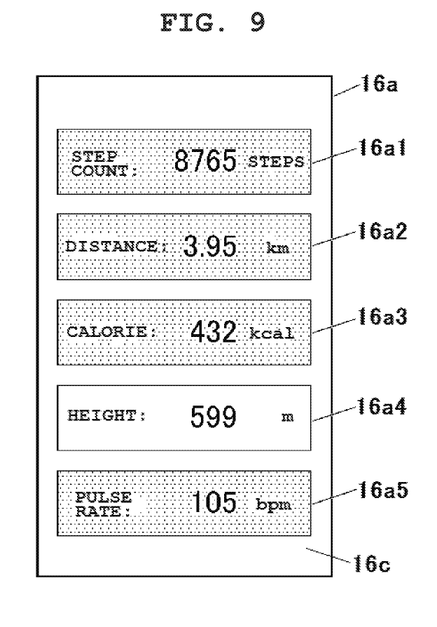

Then, the display control unit 17 lowers the brightness level of each of the first to the third display areas (16a1 to 16a3) by one step in the case that the determining unit 17a determines that the user's activity state does not change for a predetermined period of time, i.e. the user keeps walking or running for the predetermined period of time. For example, in the case the brightness level of each of the first to the third display areas (16a1 to 16a3) is the brightness level 1 (see FIG. 6A) when the determining unit 17a determines that the user keeps walking or running for the predetermined period of time, the display control unit 17 lowers the brightness level to the brightness level 2 as shown in FIG. 9. In the case the brightness level of each of the first to the third display areas (16a1 to 16a3) is the brightness level 3 (10% of brightness) when the determining unit 17a determines that the user keeps walking or running for the predetermined period of time, the display control unit 17 maintains the brightness level. On the other hand, in the case that the determining unit 17a determines that the user's activity state changes during the predetermined period of time, i.e. the activity state changes from walking to running, or from running to walking, the display control unit 17 controls the brightness level of each of the first to the third display areas (16a1 to 16a3) so as to become the brightness level 1 (normal brightness; 100% of brightness).

The determining unit 17a determines on what floor of a building the user is located based on the height data deduced by the activity information deducing unit 15. Here, it is supposed that the height of one floor of the building is four (4) meters. For example, in the case that the height deduced by the activity information deducing unit 15 is 15 meters, the determining unit 17a determines that the user is on the fourth floor.

In the case that the determining unit 17a determines that the user's activity state does not change for a predetermined period of time, i.e. the user is on the same floor for the predetermined period of time, the display control unit 17 lowers the brightness level of the fourth display area 16a4 by one step. In the case the brightness level of the fourth display area 16a4 is the brightness level 3 (10% of brightness) when the determining unit 17a determines that the user's activity state does not change, the display control unit 17 maintains the brightness level.

On the other hand, in the case that the determining unit 17a determines that the user's activity state changes during the predetermined period of time, i.e. the user moves to a different floor of the building, the display control unit 17 controls the brightness level of the fourth display area 16a4 so as to become the brightness level 1 (normal brightness; 100% of brightness).

Further, the determining unit 17a determines whether the user is standing still, walking, or running based on the pulse rate data deduced by the activity information deducing unit 15. For example, the determining unit 17a determines that the user is running in the case that the pulse rate is greater than or equal to a first threshold value, that the user is walking in the case that the pulse rate is smaller than the first threshold value and greater than or equal to a second threshold value (the second threshold value is smaller than the first threshold value), or that the user stands still in the case that the pulse rate is smaller than the second threshold value.

In the case that the determining unit 17a determines that the user's activity state does not change for a predetermined period of time, i.e. the user keeps standing still, keeps walking, or keeps running for the predetermined period of time, the display control unit 17 lowers the brightness level of the fifth display area 16a5 by one step. In the case the brightness level of the fifth display area 16a5 is the brightness level 3 (10% of brightness) when the determining unit 17a determines that the user's activity state does not change, the display control unit 17 maintains the brightness level.

On the other hand, in the case that the determining unit 17a determines that the user's activity state changes during the predetermined period of time (for example, the activity state changes from standing still to walking), the display control unit 17 controls the brightness level of the fifth display area 16a5 so as to become the brightness level 1 (normal brightness; 100% of brightness).

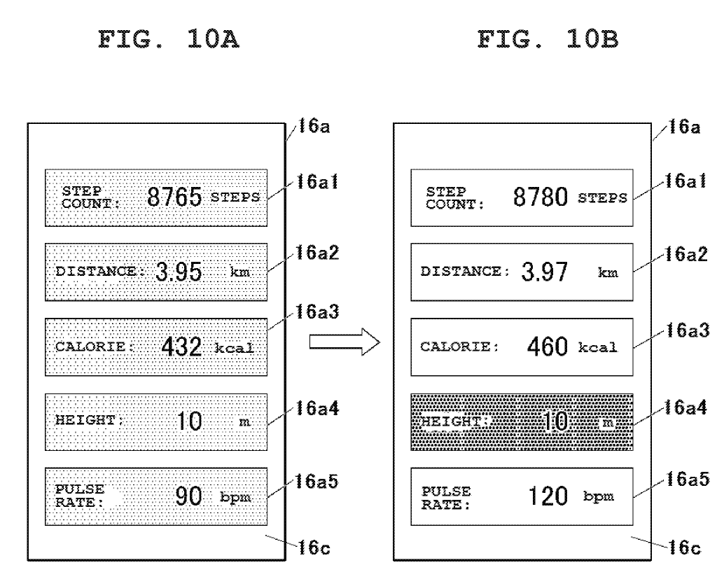

Now, examples of display of the display unit 16 are explained, for example, when the user standing still on flat land (at a place of uniform height) starts to run so that the activity state changes to running by referring to FIGS. 10A and 10B.

FIG. 10A is a diagram showing an example of display of the display unit 16 when the user stands still on the flat land (at the place of uniform height). FIG. 10B is a diagram showing an example of display of the display unit when the user's activity state changes to running.

In the case that the user stands still on the flat land (at the place of uniform height) for a predetermined period of time, the determining unit 17a determines that the user's activity state does not change as described above and the brightness level of each of the first to the fifth display areas (16a1 to 16a5) can be lowered by one step (for example, the brightness level 2) as shown in FIG. 10A. Then, in the case that the user changes his/her activity to running on the flat land, the determining unit 17a determines that the user's activity state changes. As shown in FIG. 10B, the display control unit 17 controls the brightness levels of the first to the third display areas (16a1 to 16a3) and the fifth display area (16a5) to become the brightness level 1 (normal brightness; 100% of brightness) so that information having relevance to/high relevance to (changing according to) the user's activity state after the change (the running state), i.e. the step count data, the distance data, the calorie data, and the pulse rate data, can be seen easily. Thus, the first to the third display areas (16a1 to 16a3) and the fifth display area (16a5) are highlighted compared to other display areas. On the other hand, since the height data (information having no relevance to/low relevance to (not changing according to) the user's activity state after the change) does not change in this case, the brightness level of the fourth display area (16a4) is lowered by one step (for example, the brightness level 3). The criterion for the determination on the relevance to the user's activity state after the change is not limited to whether or not the indicator information acquired by each sensor changes. For example, in the case that a change in the indicator information is very small, the data corresponding to the indicator information may be determined to have low relevance to the user's activity state after the change. In the case that the indicator information changes to some degree, the data corresponding to the indicator information may be determined to have high relevance to the user's activity state after the change.

The manipulation unit 18 is an electrostatic capacity type touch panel provided on the display panel 16a of the display unit 16. The manipulation unit 18 detects the position and the kind of the user's touch manipulation on the touch panel and generates a signal according to the manipulation to output it to the CPU 11 as an input signal.

The clock unit 19 includes a timer or a clock circuit (not shown in the drawings), for example. The clock unit 19 acquires time information by checking the present time. Then, the clock unit 19 outputs the acquired time information to the CPU 11.

The power supply unit 20 supplies power for operations of the wearable terminal 100 at a predetermined voltage. The power supply unit 20 may include various types of batteries (a lithium battery, a nickel-hydride rechargeable battery, and the like), for example. In the present embodiment, the power supply unit 20 supplies power to the CPU 11.

<First to Third Display Areas Control Process>

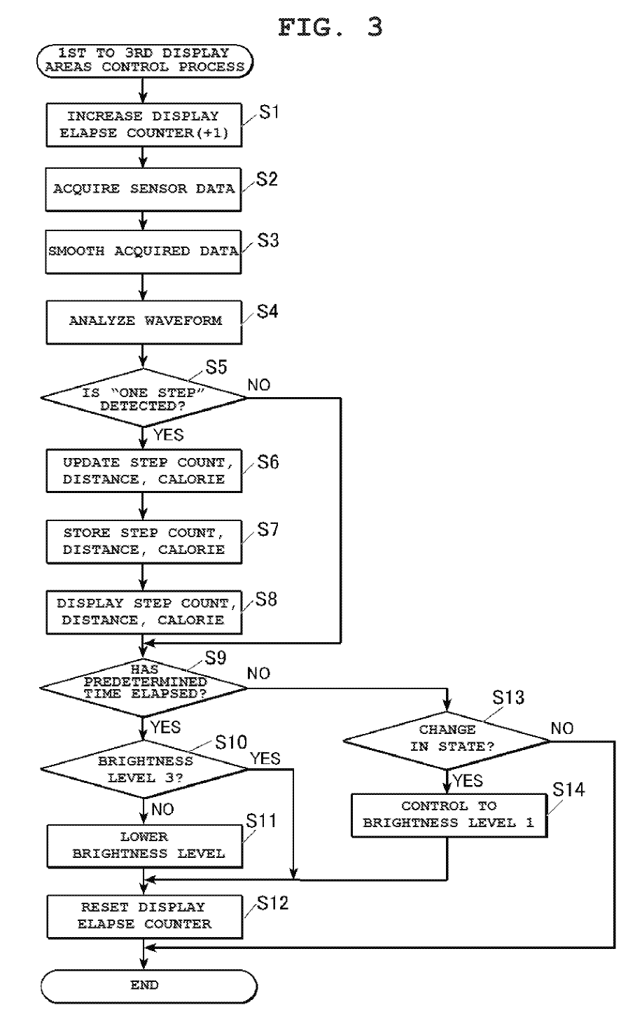

In the following, a first to third display areas control process by the wearable terminal 100 will be described with reference to FIG. 3.

FIG. 3 is a flow chart showing an example of the first to third display areas control process. The first to third display areas control process is started at every sampling period of the sensor data (the acceleration information) acquired by the acceleration sensor 14a.

As shown in FIG. 3, the clock unit 19 increases the value of a display elapse counter (increment +1) (Step S1). Then, the activity information deducing unit 15 acquires the acceleration information (the sensor data) detected by the acceleration sensor 14a from the RAM 13 (Step S2). The activity information deducing unit 15 smoothes the acquired acceleration information (Step S3), and analyzes the waveform signal (Step S4).

The activity information deducing unit 15 determines whether or not a peak value is detected from the waveform signal, i.e. the user's step (one step) is detected from the waveform signal (Step S5).

In the case that it is determined at Step S5 that a peak value is detected from the waveform signal (Step S5; YES), the activity information deducing unit 15 updates (deduces) the step count data, the distance data, and the calorie data (Step S6), and stores the data in a predetermined storage area(s) of the RAM 13 (Step S7). The display control unit 17 generates data for display from each of the step count data, the distance data, and the calorie data stored in the RAM 13 and controls each of the first to the third display areas (16a1 to 16a3) to display the data, respectively (Step S8).

On the other hand, in the case that it is determined at Step S5 that no peak value is detected from the waveform signal (Step S5; NO), the process skips Steps S6 to S8 and proceeds to Step S9.

Then, the display control unit 17 determines whether or not a predetermined period of time has elapsed, i.e. the value of the display elapse counter reaches a predetermined value (Step S9).

In the case that it is determined at Step S9 that the predetermined period of time has elapsed (Step S9; YES), the display control unit 17 determines whether or not the brightness level of each of the first to the third display areas (16a1 to 16a3) is already the brightness level 3 (10% of brightness) (Step S10).

In the case that it is determined at Step S10 that the brightness level is not the brightness level 3 (Step S10; NO), the display control unit 17 lowers the brightness level of each of the first to the third display areas (16a1 to 16a3) by one step (Step S11). Then, the clock unit 19 resets the display elapse counter (Step S12), and the first to third display areas control process ends.

On the other hand, it is determined at Step S10 that the brightness level is the brightness level 3 (Step S10; YES), the process skips Step S11, the clock unit 19 resets the display elapse counter (Step S12), and the first to third display areas control process ends.

In the case that it is determined at Step S9 that the predetermined period of time has not elapsed (Step S9; NO), the determining unit 17a determines whether or not the user's activity state changes, i.e. it changes from walking to running or from running to walking (Step S13).

In the case that it is determined at Step S13 that the user's activity state does not change (Step S13; NO), the first to third display areas control process ends.

On the other hand, in the case that it is determined at Step S13 that the user's activity state changes (Step S13; YES), the display control unit 17 controls the brightness level of each of the first to the third display areas (16a1 to 16a3) so as to become the brightness level 1 (normal brightness; 100% of brightness) (Step S14). Then, the clock unit 19 resets the display elapse counter (Step S12) and the first to third display areas control process ends.

<Fourth Display Area Control Process>

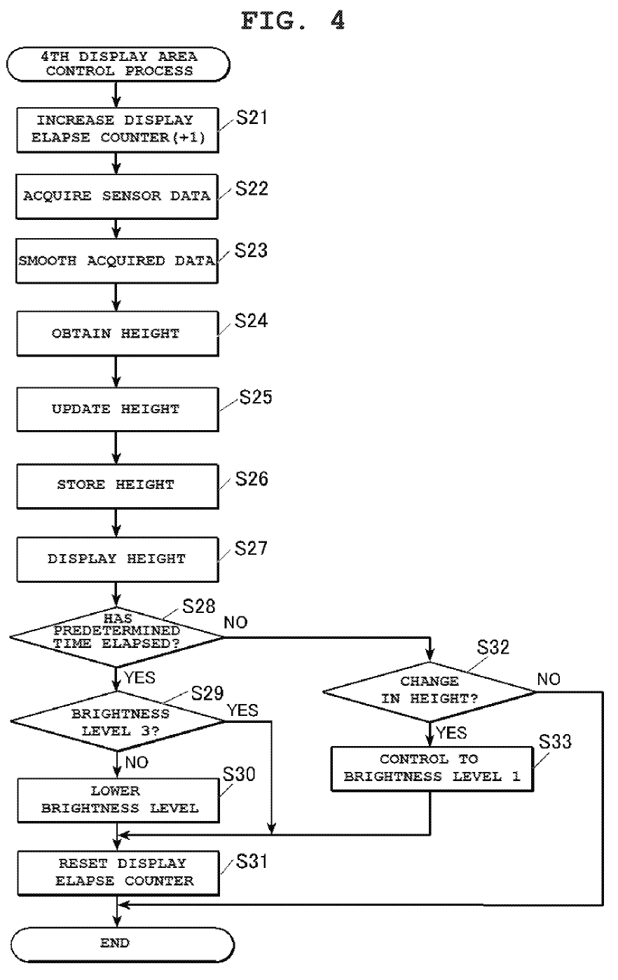

In the following, a fourth display area control process by the wearable terminal 100 will be described with reference to FIG. 4.

FIG. 4 is a flow chart showing an example of the fourth display area control process. The fourth display area control process is started at every sampling period of the sensor data (the air pressure information) acquired by the pressure sensor 14b.

As shown in FIG. 4, the clock unit 19 increases the value of a display elapse counter (increment +1) (Step S21). Then, the activity information deducing unit 15 acquires the air pressure information (the sensor data) detected by the pressure sensor 14b from the RAM 13 (Step S22). The activity information deducing unit 15 smoothes the acquired air pressure information (Step S23) and obtains the height at which the user is (Step S24).

The activity information deducing unit 15 updates the height data (Step S25), and stores the data in a predetermined storage area of the RAM 13 (Step S26). The display control unit 17 generates data for display from the height data stored in the RAM 13 and controls the fourth display area (16a4) to display the data (Step S27).

Then, the display control unit 17 determines whether or not a predetermined period of time has elapsed, i.e. the value of the display elapse counter reaches a predetermined value (Step S28).

In the case that it is determined at Step S28 that the predetermined period of time has elapsed (Step S28; YES), the display control unit 17 determines whether or not the brightness level of the fourth display area (16a4) is already the brightness level 3 (10% of brightness) (Step S29).

In the case that it is determined at Step S29 that the brightness level is not the brightness level 3 (Step S29; NO), the display control unit 17 lowers the brightness level of the fourth display area (16a4) by one step (Step S30). Then, the clock unit 19 resets the display elapse counter (Step S31), and the fourth display area control process ends.

On the other hand, it is determined at Step S29 that the brightness level is the brightness level 3 (Step S29; YES), the process skips Step S30, the clock unit 19 resets the display elapse counter (Step S31), and the fourth display area control process ends.

In the case that it is determined at Step S28 that the predetermined period of time has not elapsed (Step S28; NO), the determining unit 17a determines whether or not the height at which the user is changes, i.e. the user moves from a floor of a building to a different floor in the building (Step S32).

In the case that it is determined at Step S32 that the height at which the user is does not change, i.e. the user does not move to a different floor of the building (Step S32; NO), the fourth display area control process ends.

On the other hand, in the case that it is determined at Step S32 that the height at which the user is changes, i.e. the user moves from the floor of the building to a different floor in the building (Step S32; YES), the display control unit 17 controls the brightness level of the fourth display area (16a4) so as to become the brightness level 1 (normal brightness; 100% of brightness) (Step S33). Then, the clock unit 19 resets the display elapse counter (Step S31), and the fourth display area control process ends.

<Fifth Display Area Control Process>

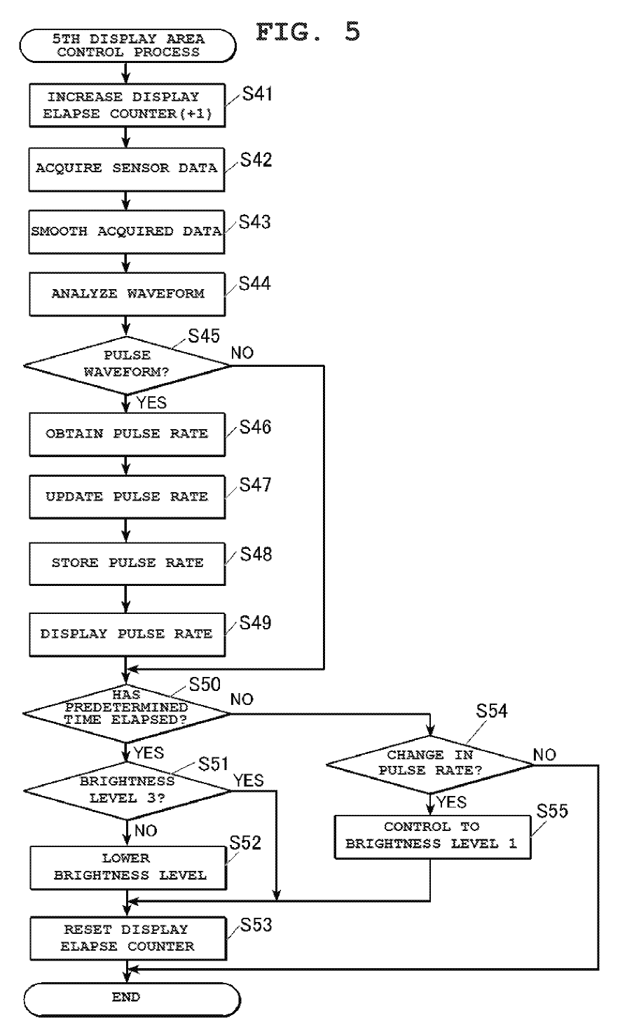

In the following, a fifth display area control process by the wearable terminal 100 will be described with reference to FIG. 5.

FIG. 5 is a flow chart showing an example of the fifth display area control process. The fifth display area control process is started at every sampling period of the sensor data (the light quantity information) acquired by the pulse sensor 14c.

As shown in FIG. 5, the clock unit 19 increases the value of a display elapse counter (increment +1) (Step S41). Then, the activity information deducing unit 15 acquires the light quantity information (the sensor data) detected by the pulse sensor 14c from the RAM 13 (Step S42). The activity information deducing unit 15 smoothes the acquired acceleration information (Step S43), and analyzes the waveform signal (Step S44).

The activity information deducing unit 15 determines whether or not a waveform pattern based on the analyzed waveform signal accords with a pulse waveform pattern (Step S45).

In the case that it is determined at Step S45 that the waveform pattern accords with the pulse waveform pattern (Step S45; YES), the activity information deducing unit 15 obtains a pulse rate from the analyzed waveform signal (Step S46), updates the pulse rate data (Step S47), and stores the data in a predetermined storage area of the RAM 13 (Step S48). The display control unit 17 generates data for display from the pulse rate data stored in the RAM 13 and controls the fifth display area (16a5) to display the data (Step S49).

On the other hand, in the case that it is determined at Step S45 that the waveform pattern does not accord with the pulse waveform pattern (Step S45; NO), the process skips Steps S46 to S49 and proceeds to Step S50.

Then, the display control unit 17 determines whether or not a predetermined period of time has elapsed, i.e. the value of the display elapse counter reaches a predetermined value (Step S50).

In the case that it is determined at Step S50 that the predetermined period of time has elapsed (Step S50; YES), the display control unit 17 determines whether or not the brightness level of the fifth display area (16a5) is already the brightness level 3 (10% of brightness) (Step S51).

In the case that it is determined at Step S51 that the brightness level is not the brightness level 3 (Step S51; NO), the display control unit 17 lowers the brightness level of the fifth display area (16a5) by one step (Step S52). Then, the clock unit 19 resets the display elapse counter (Step S53), and the fifth display area control process ends.

On the other hand, it is determined at Step S51 that the brightness level is the brightness level 3 (Step S51; YES), the process skips Step S52, the clock unit 19 resets the display elapse counter (Step S53), and the fifth display area control process ends.

In the case that it is determined at Step S50 that the predetermined period of time has not elapsed (Step S50; NO), the determining unit 17a determines whether or not the user's pulse rate changes (Step S54).

In the case that it is determined at Step S54 that the user's pulse rate does not change (Step S54; NO), the fifth display area control process ends.

On the other hand, in the case that it is determined at Step S13 that the user's pulse rate changes (Step S54; YES), the display control unit 17 controls the brightness level of the fifth display area (16a5) so as to become the brightness level 1 (normal brightness; 100% of brightness) (Step S55). Then, the clock unit 19 resets the display elapse counter (Step S53) and the fifth display area control process ends.

According to the wearable terminal 100 of the present embodiment as described above, the sensor unit 14 detects the indicator information showing the user's activity state, the display unit 16 displays the information on the user's activity state, the determining unit 17a determines whether or not the user's activity state changes based on the indicator information detected by the sensor unit 14, and, in the case that the determining unit 17a determines the user's activity state changes, the display control unit 17 controls the display unit 16 so that information having relevance to the user' activity state after the change is highlighted and can be seen easily compared to information having low relevance to the user' activity state after the change.

Thus, brightness of the backlight 16b does not need to be always the brightness level 1 (100% of brightness) and can be adjusted according to the user's activity state. The brightness level of the backlight 16b can be lowered for a display area for showing information having low relevance to the user's activity state after the change. The brightness level of the backlight 16b is returned to its original level for a display area for showing information having relevance to the user's activity state after the change so that the display area is highlighted and the information can be seen easily.

By this, since power consumption can be suppressed while the brightness level of the backlight 16b is low, the wearable terminal can endure a long term use.

Further, according to the wearable terminal 100 of the present embodiment, the brightness level of the backlight 16b is lowered in the case that the determining unit 17a determines that the user's activity state does not change for a predetermined period of time.

It can be assumed that there is no a significant change in contents displayed by the display unit 16 and the user is not interested in the contents in the case that the determining unit 17a determines that the user's activity state does not change. In this case, power consumption can be efficiently suppressed by lowering the brightness level of the backlight 16b without causing any inconvenience.

Further, according to the wearable terminal 100 of the present embodiment, the brightness of the backlight 16b is controlled to become the brightness level of the normal state (the brightness level 1) in the case that the determining unit 17a determines the user's activity state changes during the predetermined period of time.

It can be assumed that there is a significant change in contents displayed by the display unit 16 and the user is interested in the contents in the case that the determining unit 17a determines that the user's activity state changes. Thus, the power consumption can be saved because the brightness level of the backlight 16b can be controlled to be the normal level in the above case.

Further, according to the wearable terminal 100 of the present embodiment, in the case that the determining unit 17a determines that the user's activity state does not change for a predetermined period of time, the brightness of a display area in which activity information used for the determination by the determining unit 17a is displayed is lowered.

Thus, it is possible to lower the brightness level of only a part of the backlight 16b corresponding to a display area in which the user may not be interested. Therefore, the power consumption can be efficiently suppressed by lowering the brightness level of the backlight 16b without causing any inconvenience.

Further, according to the wearable terminal 100 of the present embodiment, in the case that the determining unit 17a determines that the user's activity state changes during the predetermined period of time, the brightness of a display area in which activity information used for the determination by the determining unit 17a is displayed is controlled to be the normal level.

Thus, it is possible to control the brightness level of only a part of the backlight 16b corresponding to a display area in which the user may be interested to be the normal level. The brightness levels of parts of the backlight 16b corresponding to the remaining display area are not raised. Therefore, the power consumption can be efficiently suppressed.

In addition, the present invention is not limited to the above described embodiments and various modifications and design changes are possible without departing the scope of the invention.

For example, in the above embodiments, the brightness level can be controlled to be one of the three steps, i.e. the brightness level 1, the brightness level 2, and the brightness level 3. However, the present invention is not limited to thereto. In some embodiments, a plurality of brightness levels can be set between a brightness level 1, which is the upper limit, and a brightness level 4, which is the lower limit (for example, the brightness level 1 (100% of brightness), a brightness level 2 (75% of brightness), a brightness level 3 (50% of brightness), and the brightness level 4 (0% of brightness)). The value of the brightness level (the value of percentage of the brightness level) may be set by the user.

In some embodiments, contrast between the display areas (16a1 to 16a5) and the background area 16c or between each of the display areas (16a1 to 16a5) and the other display areas can be adjusted.

In the above embodiments, in the case that the determining unit 17a determines that the user's activity state does not change, the brightness of the display area in which the activity information used for the determination by the determining unit 17a is displayed is lowered by one step. However, the method for controlling the brightness level is not limited thereto. For example, in an embodiment where a plurality of brightness levels can be set between the brightness level 1 (100% of brightness), which is the upper limit, and the brightness level 4 (0% of brightness), which is the lower limit, as described above, and the wearable terminal includes an illuminance sensor, the brightness level can be lowered to a level suitable for illuminance detected by the illuminance sensor.

In the above embodiments, in the case that the user's activity state changes, the brightness level of each of display areas for displaying information having relevance to the user's activity state after the change is controlled. However, in other embodiments, in the case that the user's activity state changes, the brightness levels of all of the display areas for displaying information on the user's activity can be controlled.

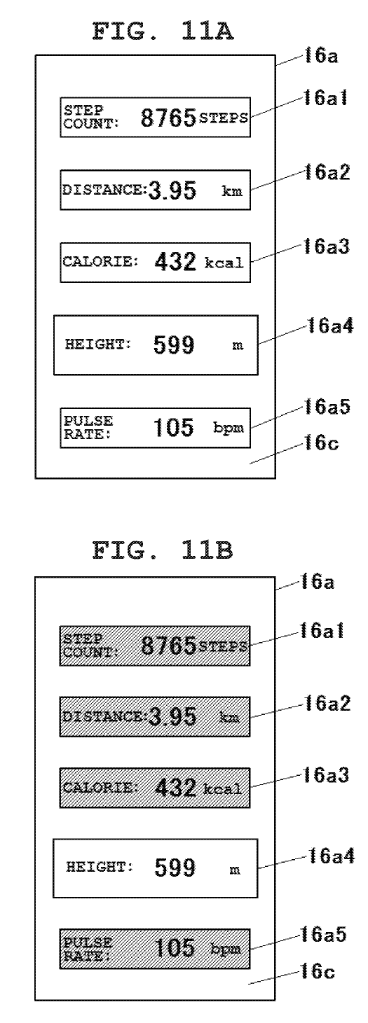

In the above embodiments, in the case that the user's activity state changes, the brightness level of each of the display areas for displaying the information having relevance to the user's activity state after the change is controlled. In some embodiments, the size of an area for displaying the user's activity information is changed in the case that the user's activity state changes. For example, as shown in FIG. 11A, in the case that the user's activity state changes, the size of a display area of a plurality of display areas in which information having high relevance to the user's activity state is being displayed is maintained (or increased) and the sizes of display areas of the plurality of display areas in which information having low relevance to the user's activity state is being displayed are reduced such that the information having high relevance to the user's activity state after the change can be highlighted. The information having high relevance to the user's activity state can be emphasized by changing the size of the display area without changing the brightness. Therefore, the information necessary for the user can be seen easily. Further, the power consumption can be suppressed because the area used for display is reduced. In addition, the change in the brightness of the display area and the change in the size of the display area can be performed at the same time as shown in FIG. 11B. By this, the information having high relevance to the user's activity state is emphasized more fully. Therefore, the information necessary for the user can be seen easily and the power consumption can be suppressed.

Furthermore, according to the above described embodiments, functions as the activity information deducing means, the determining means, and the control means are realized by driving the activity information deducing unit, the determining unit, and the display control unit under control of the main CPU 11, but the present invention is not limited thereto. The functions may be realized by executing a predetermined program by the main CPU 11.

More specifically, a program memory (not shown in the drawings) stores a program including an activity information deducing process routine, a determining process routine, and a display control process routine. The activity information deducing process routine may control the main CPU 11 to function as a means for deducing activity information relating to a person's activity state based on the indicator information detected by the sensor unit 14. The determining process routine may control the main CPU 11 to function as a means for determining the person's activity state based on the activity information deduced by the activity information deducing process routine. Further, the display control process routine may control the main CPU 11 to function as a means for controlling the brightness of the display unit 16 (the backlight 16b) based on the person's activity state determined by the determining process routine.

In addition, the display apparatus of the present invention has been described by using the wearable terminal as an example in the above embodiments, but the present invention is not limited to these embodiments. For example, the present invention can be applied to a terminal such as a mobile phone, a smart phone, or a PDA (Personal Data Assistants).

Although some embodiments of the present invention have been described above, the embodiments are for illustrative purposes only and not intended to limit the technical scope of the present invention. It will be evident that there are many other possible embodiments of the present invention and various modifications such as omission or substitution may be made without departing from the spirit of the invention. These embodiments and modifications fall within the scope and the spirit of the invention described in this specification and within the scope of the invention as defined in the appended claims and equivalents thereof.

What is claimed is:

1. A display control method performed by a control unit for controlling a display unit of a display apparatus comprising:
determining whether or not a user's activity state changes based on at least one of pieces of indicator information, the pieces of indicator information being detected by at least one sensor and being associated with the user's activity state; and
controlling the display unit which includes a first display area and a second display area such that a display in the first display area is emphasized as compared with a display in the second display area in the case that it is determined that the user's activity state changes,
wherein the display in the first display area is corresponding to first information of the pieces of indicator information, the display in the second display area is corresponding to second information of the pieces of indicator information, and the second information is different from the first information, and
wherein the first information has high relevance to the changed user's activity state compared to the second information.

2. The display control method of claim 1, wherein controlling the display unit comprises performing at least one of operations to raise brightness and to increase the size of the first display area of the display unit in the case that it is determined that the user's activity state changes.

3. The display control method of claim 1, wherein controlling the display unit comprises performing at least one of operations to lower brightness and to decrease the size of the second display area of the display unit in the case that it is determined that the user's activity state does not change for a predetermined period of time.

4. The display control method of claim 1, wherein the first display area having high relevance to the user's activity state corresponds to indicator information changing in a predetermined manner.

5. The display control method of claim 1, wherein the user's activity state includes walking, running, standing still, and a height at which the user is located.

6. The display control method of claim 1, wherein at least one kind of indicator information is used.

7. The display control method of claim 1 further comprising deducing activity information related to the user's activity state based on the indicator information.

8. The display control method of claim 7, wherein a plurality of kinds of activity information is deduced.

9. A display apparatus comprising:
a display unit comprising a first display area and a second display area, each of a plurality of kinds of activity information related to a user's activity state being displayed in each of the display areas; and
a control unit configured to determine whether or not the user's activity state changes based on at least one of pieces of indicator information, the pieces of indicator information being detected by at least one sensor and being associated with the user's activity state, and control the display unit which includes the first display area and the second display area such that a display in the first display area is emphasized as compared with a display in the second display area in the case of determining that the user's activity state changes,
wherein the display in the first display area is corresponding to first information of the pieces of indicator information, the display in the second display area is corresponding to second information of the pieces of indicator information, and the second information is different from the first information, and
wherein the first information has high relevance to the changed user's activity state compared to the second information.

10. The display apparatus of claim 9, wherein the control unit performs at least one of operations to raise brightness and to increase the size of the first display area of the display unit in the case of determining that the user's activity state changes.

11. The display apparatus of claim 9, wherein the control unit performs at least one of operations to lower brightness and to decrease the size of the second display area of the display unit in the case of determining that the user's activity state does not change for a predetermined period of time.

12. The display apparatus of claim 9, wherein the control unit deduces at least one of the plurality of kinds of activity information related to the user's activity state based on the indicator information.

13. The display apparatus of claim 9 further comprising at least one indicator information detecting unit configured to detect the indicator information.

14. A non-transitory computer-readable recording medium for recording a program for controlling a display apparatus comprising a processor and a display unit, the program causing the processor, when executed by the processor, to perform operations to:
determine whether or not a user's activity state changes based on at least one of pieces of indicator information, the pieces of indicator information being detected by at least one sensor and being associated with the user's activity state; and
control the display unit which includes a first display are and a second display area such that a display in the first display area is emphasized as compared with a display in the second display area in the case that it is determined that the user's activity state changes,
wherein the display in the first display area is corresponding to first information of the pieces of indicator information, the display in the second display area is corresponding to second information of the pieces of indicator information, and the second information is different from the first information, and
wherein the first information has high relevance to the changed user's activity state compared to the second information.

15. The non-transitory computer-readable recording medium of claim 14, wherein the operation to control the display unit comprises at least one of operations to raise brightness and to increase the size of the first display area of the display unit in the case that it is determined that the user's activity state changes.

16. The non-transitory computer-readable recording medium of claim 14, wherein the operation to control the display unit comprises at least one of operations to lower brightness and to decrease the size of the second display area of the display unit in the case that it is determined that the user's activity state does not change for a predetermined period of time.
